(19) United States
(12) Patent Application Publication
(10) Pub. No.: US 2013/0095699 A1
(43) Pub. Date: Apr. 18, 2013

(54) HEADPHONES WITH AUXILIARY CABLE

(71) Applicants: Michael Junior Brun, Orlando, FL (US); Mike Bruno Brun, Orlando, FL (US)

(72) Inventors: Michael Junior Brun, Orlando, FL (US); Mike Bruno Brun, Orlando, FL (US)

(21) Appl. No.: 13/273,843

(22) Filed: Oct. 14, 2011

(51) Int. Cl. H01R 33/00; H01R 43/00

(52) U.S. Cl. 439/638; 29/857

(57) ABSTRACT

A headphone set is provided having a pair of headphones, a female connector, a first set of wires, and an auxiliary cable. The first set of wires may electrically connect the pair of headphones with the female connector. The auxiliary cable may include first and second male connectors and a second set of wires electrically connecting the first and second male connectors. The first male connector may be configured to removably plug into the female connector and the second male connector may be configured to removably plug into music player devices.

### BACKGROUND OF THE INVENTION

The present invention generally relates to a headphone set with a removable auxiliary cable.

A conventional headphone set include a cable that is wired to the headphones, such as earbuds, at one end and wired to a male connector or plug at the other end. To use, the plug is plugged into a music player, such as a portable MP3 player. In order to use the music player in an automobile or at home with a stereo, a separate auxiliary cable with a plug at each end may be necessary.

As can be seen, the use of a conventional headphone set may be inconvenient.

### SUMMARY OF THE INVENTION

In one aspect of the present invention, a headphone set is provided having a pair of headphones, a female connector, a first set of wires, and an auxiliary cable. The first set of wires may electrically connect the pair of headphones with the female connector. The auxiliary cable may include first and second male connectors and a second set of wires electrically connecting the first and second male connectors. The first male connector may be configured to removably plug into the female connector and the second male connector may be configured to removably plug into music player devices.

In another aspect of the present invention, a headphone set is provided having a set of wires, a pair of headphones electrically connected to first end of the set of wires, and a female connector, electrically connected to a second end of the set of wires. The female connector may be configured to removably receive a corresponding first male connector at a first end of an auxiliary cable. The auxiliary cable may have a second male connector at a second end configured to removably plug into music player devices.

In still another aspect of the present invention, a method of making a headphone set is provided. The method includes providing a set of headphones, electrically connecting the set of headphones to a first end of a first set of wires and electrically connecting a female connector to a second end of the first set of wires. The method further includes electrically connecting a first male connector to a first end of a second set of wires and electrically connecting a second male connector to a second end of the second set of wires. The first male connector may be configured to removably plug into the female connector and the second male connector may be configured to removably plug into music player devices.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of a headphone set of the present invention plugged into a portable music player;

FIG. 2 is a perspective view of the headphone portion of the headphone set of FIG. 1; and

FIG. 3 is an exploded view of headphone set of FIG. 1 with the auxiliary cable portion alternately plugged into a portable music player and into an automobile music player.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provides a headphone set with a removable auxiliary cable.

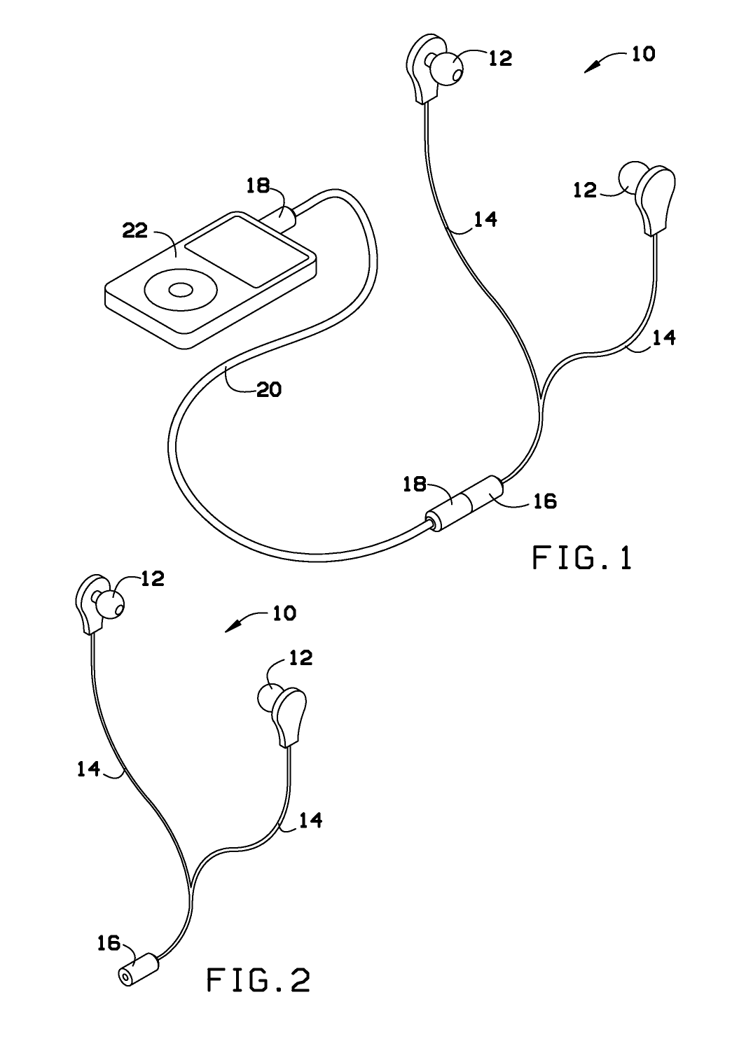

FIG. 1 is a perspective view of an exemplary embodiment of a headphone set 10 of the present invention plugged into a portable music player 22. The headphone set 10 may include headphones 12, such as earbuds, a female connector (jack) 16 and a set of wires 14 electrically connecting the headphones 12 with the female connector 16. The headphone set may also include an auxiliary cable 20 having a male connector (plug) 18 at each end electrically connected to each other with another set of wires. The female connector 16 and one of the male connectors 18 are configured to removably plug into each other. The other male connector 18 is configured to removably plug into various music players. The wires 14 and the auxiliary cable 20 may each be from about 10 inches to about 24 inches long. Any type of headphones may be used including earbuds, closed-ear headphones, and over-the-ear headphones.

The headphone set 10 may be constructed by electrically connecting one end of a pair of wires 14 to each of the pair of headphones 12. The negative wire from each headphone 12 may be electrically connected together and each of the positive wires from the headphones 12, along with the negative wires, may be electrically connected, such as by soldering, to a three-terminal female connector 16. Wires at each end of a three-wire auxiliary cable 20 may be electrically connected, also such as by soldering, to the matching terminals of three-terminal male connectors 18. If desired, the connections may be sealed, such as with heat shrink tubing or electricians tape.

An existing headphone set with a male connector on one end may be modified to accommodate an auxiliary cable 20. The existing cable may be cut in two and the exposed wires on each cut end may be stripped. The stripped wires 14 from the headphones 12 may electrically be connected, such as by soldering, to a three-terminal female connector 16. A male connector 18 may be electrically connected to the stripped wires of the other portion of the cut cable, also such as by soldering, to complete the auxiliary cable 20.

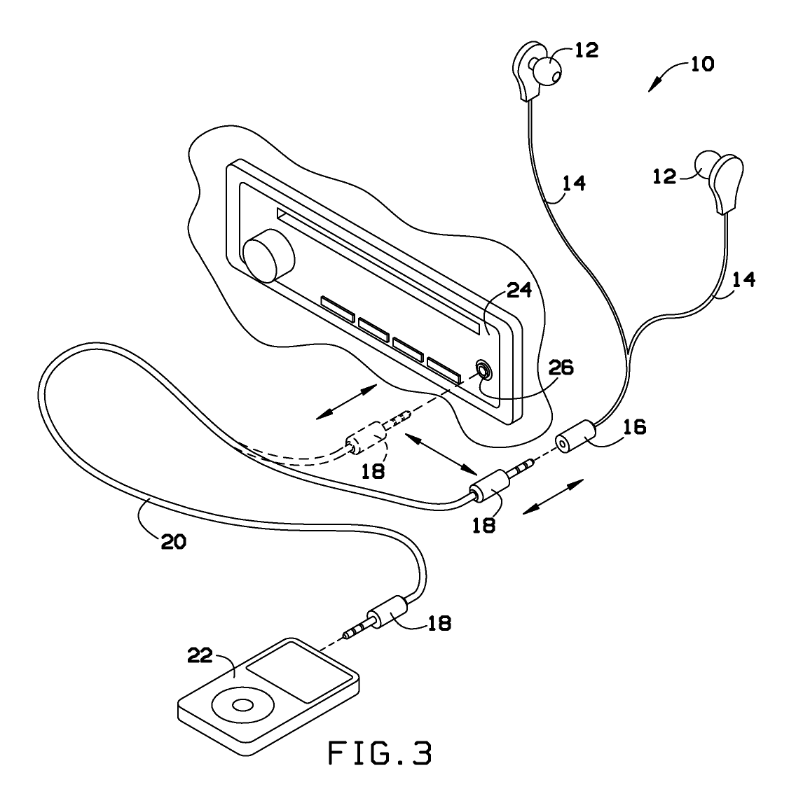

When the user wishes to listen to music or other audio from the portable music player 22 through the headphones 12, one male connector 18 of the auxiliary cable 20 may be plugged into the portable music player 22 and the other male connector 18 may be plugged into the female connector 16. When the user wishes to listen to music or other audio from the portable music player 22 through an automobile or home stereo, as illustrated in FIG. 3, the plug 18 of the auxiliary cable 20 that was plugged into the female connector 16 may be removed from the female connector 16 and plugged into a auxiliary female connector 26 of the stereo 24. The other plug 18 of the auxiliary cable 20 may remain plugged into the portable music player 22.

The auxiliary cable 20 may remain with the portable music player 22 and be used with any device that has a corresponding female connector, including the headphones 12. Thus, the user may listen to his/her portable music player 22 through the headphones 12, enter his/her car and plug the auxiliary cable 20 into the car stereo 24, and later leave the car, enter his/her house, and plug the auxiliary cable 20 into a home stereo.

It should be understood, of course, that the foregoing relates to exemplary embodiments of the invention and that modifications may be made without departing from the spirit and scope of the invention as set forth in the following claims.

What is claimed is:

1. A headphone set, comprising:
a pair of headphones;
a female connector;
a first set of wires electrically connecting the pair of headphones with the female connector; and
an auxiliary cable, comprising:
a first male connector configured to removably plug into the female connector;
a second male connector configured to removably plug into music player devices; and
a second set of wires electrically connecting the first and second male connectors.

2. The headphone set of claim 1, wherein the pair of headphones are selected from the group consisting of earbuds, closed-ear headphones, and over-the-ear headphones.

3. A headphone set, comprising:
a set of wires;
a pair of headphones electrically connected to a first end of the set of wires; and
a female connector electrically connected to a second end of the set of wires and configured to removably receive a corresponding first male connector at a first end of an auxiliary cable, the auxiliary cable having a second male connector at a second end configured to removably plug into music player devices.

4. The headphone set of claim 3, wherein the pair of headphones are selected from the group consisting of earbuds, closed-ear headphones, and over-the-ear headphones.

5. A method of making a headphone set, comprising:
providing a pair of headphones;
electrically connecting the pair of headphones to a first end of a first set of wires;
electrically connecting a female connector to a second end of the first set of wires;
electrically connecting a first male connector to a first end of a second set of wires, the first male connector configured to removably plug into the female connector; and
electrically connecting a second male connector to a second end of the second set of wires, the second male connector configured to removably plug into music player devices.

6. The method of claim 5, wherein providing the set of headphones comprises providing a set of headphones selected from the group consisting of earbuds, closed-ear headphones, and over-the-ear headphones.
